(19) United States
(12) Patent Application Publication
(10) Pub. No.: US 2025/0170696 A1
(43) Pub. Date: May 29, 2025

(54) Power tool with integrated accumulator

(71) Applicant: Hilti Aktiengesellschaft, Schaan (LI)

(72) Inventor: Wolfgang BECK, Schwabsoien (DE)

(21) Appl. No.: 18/842,852

(22) PCT Filed: Feb. 22, 2023
(86) PCT No.: PCT/EP2023/054452

§ 371 Date: Aug. 30, 2024

(30) Foreign Application Priority Data
Mar. 1, 2022 (EP) 22159558.0

(51) Int. Cl. B25F 5/02

(52) U.S. Cl. CPC B25F 5/029

(57) ABSTRACT

A machine tool containing a housing and a drive therein. The housing contains an energy storage cell in the form of a pouch cell, and an interface device for selectively supplying the at least one energy storage cell with electric power is provided. A system contains a charging device and the at least one machine tool, the machine tool containing a first communication device, at least one energy storage cell which is designed as a pouch cell, and a machine tool interface device, and the charging device contains a second communication device and a loader interface device such that the charging device and the machine tool can be connected in order to charge the at least one energy storage cell with electric energy. The loader interface device is designed in the form of a USB plug, and the machine tool interface device is designed in the form of a USB socket.

The present invention relates to a power tool containing a housing and a drive positioned in the housing.

Furthermore, the present invention relates to a system containing a charging apparatus and at least one power tool, which is able to be connected to the charging apparatus.

### BACKGROUND

Power tools which are supplied with electrical energy from an accumulator are very well known from the prior art. For this purpose, the accumulator essentially contains a multiplicity of energy storage cells (also called accumulator cells) positioned in a solid housing. By means of the energy storage cells, electrical energy can be stored by the accumulator and also provided for a power tool.

On one side of the housing of the accumulator, provision is made here for an interface by way of which the accumulator can be releasably connected either to a power tool or to charging apparatus. In order to charge an accumulator with electrical energy, the accumulator is releasably connected to the charging apparatus. According to the prior art, the charging apparatuses have an interface on one side of the housing of the charging apparatus, by way of which interface the accumulator is mechanically and electrically connected to the charging apparatus.

### SUMMARY OF THE INVENTION

Charging apparatuses, and in particular those which are used for charging the accumulators for power tools, have a relatively elaborate and complex configuration. The relatively elaborate and complex configuration of these charging apparatuses is due to the fact that the charging apparatuses are used, inter alia, in harsh or strenuous environments (e.g. on construction sites or in workshops) and at the same time sophisticated accumulators have to be supplied with electrical energy in—in some instances—complicated charging processes. For this purpose, these charging apparatuses, on the one hand, have to have a very solid and durable configuration and, on the other hand, have to be configured with sensitive technology.

The configuration of the interface on the charging apparatus constitutes a particular technical challenge here. This is because the interface is usually open outwardly and the electrical connections are therefore also exposed to the risk of water and/or dust being able to penetrate through them into the interior of the charging apparatus. The penetrating water can lead, inter alia, to short circuits in the charging apparatus and consequently permanently damage the charging apparatus. Penetrating dust and other dirt can damage the charging apparatus as well.

It is an object of the present invention to solve the problem described above.

The present invention provides a power tool containing a housing and a drive positioned in the housing.

It is provided in accordance with the invention that at least one energy storage cell in the form of a pouch cell is positioned inside the housing and at least one interface device is contained for selectively supplying the at least one energy storage cell with electrical energy.

According to an alternative embodiment, it may be possible for the at least one interface device to be configured in the form of a USB socket.

According to an alternative embodiment, it may be possible for the interface device to be configured to allow a supply of the at least one energy storage cell with a voltage value of 21 to 60 V, in particular 48 V.

According to an alternative embodiment, it may be possible for the interface device to be configured to allow a supply of the at least one energy storage cell with a current intensity value of 1 to 10 A, in particular 5 A.

According to an alternative embodiment, it may be possible for the interface device to be configured to allow a supply of the at least one energy storage cell with a charging power of 21 to 600 W, in particular 240 W.

Furthermore, the object is achieved by a system containing a charging apparatus and at least one power tool, which is able to be connected to the charging apparatus.

According to the invention, provision is made in the system for the power tool to contain a first communication device, at least one energy storage cell configured as a pouch cell, and a power tool interface device, and for the charging apparatus to contain a second communication device and a charger interface device, such that the charging apparatus and the power tool are able to be connected in order to charge the at least one energy storage cell with electrical energy, wherein the charger interface device is configured in the form of a USB plug connector and the power tool interface device is configured in the form of a USB socket.

Further advantages will become apparent from the following description of the figures. Various exemplary embodiments of the present invention are illustrated in the figures.

### BRIEF DESCRIPTION OF THE DRAWINGS

The figures, the description and the claims contain numerous features in combination. A person skilled in the art will expediently also consider the features individually and combine them to produce useful further combinations.

In the drawing:

FIG. 1 shows a schematic side view of a power tool according to a first embodiment and a charging apparatus, connected to the power tool, according to a first embodiment; and

FIG. 2 shows a schematic side view of the power tool according to a second embodiment and a charging apparatus, connected to the power tool, according to a second embodiment.

### DETAILED DESCRIPTION

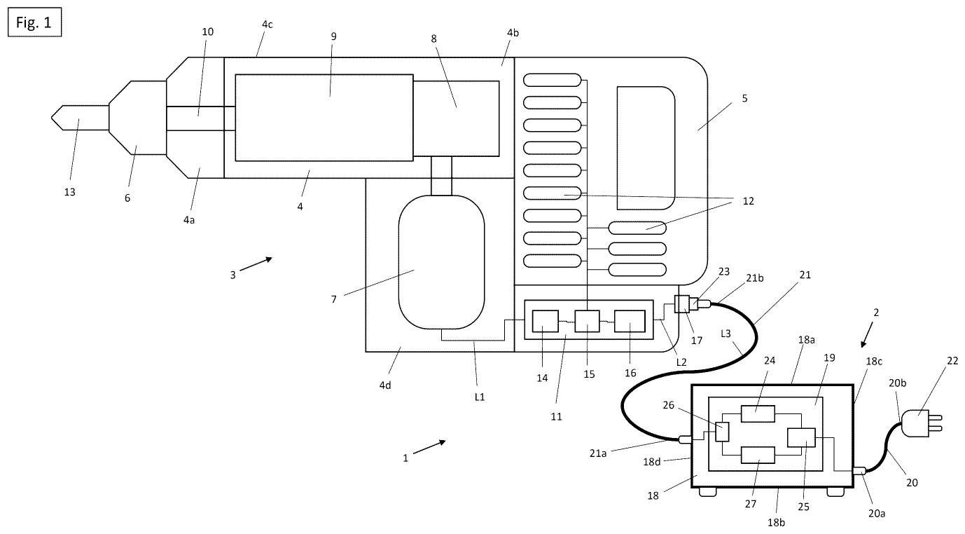

FIG. 1 shows a system 1 according to the invention made up of a charging apparatus 2 according to the invention and a power tool 3 according to the invention according to a first embodiment.

The power tool 3 is configured for example in the form of a hammer drill. Alternatively, the power tool 3 can also be designed in the form of a power drill, a saw, a grinder or the like.

As also shown in FIG. 1, the power tool 3 fundamentally contains a housing 4, a handle 5, a tool fitting 6, a drive 7, a gear device 8, an impact device 9, an output shaft 10, a control device 11, and a number of energy storage cells 12.

The housing 4 here contains fundamentally a front end 4a, a rear end 4b, an upper end 4c and a lower end 4d.

The handle 5 is used to hold and guide the power tool 3 and is positioned at the rear end 4b of the housing 4.

The tool fitting 6 serves to receive and hold a tool 13, embodied as a drill, and is positioned at the front end 4a of the housing 4.

The drive 7 is embodied in the form of a brushless electric motor and serves for generating a torque.

As also shown in FIG. 1, the drive 7 is designed as an electric motor, the gear device 8, the impact device 9, the output shaft 10 and the tool fitting 6 are arranged relative to one another in the housing 4 of the power tool 3 in such a way that the torque generated in the drive 7 is transmitted to the tool fitting 6 via the gear device 8, the impact device 9, and the output shaft 10.

The energy storage cells 12 are used in particular as an energy supply for the drive 7 and are embodied in the form of pouch cells. According to the first embodiment, the energy storage cells 12 embodied as pouch cells are positioned in a cavity HR of the housing 4 in the vicinity of the handle 5; cf. FIG. 1. The energy storage cells 12 are connected to one another and via corresponding lines to the control device 11. The control device 11 is in turn connected with a corresponding line L1 to the drive 7. By way of the line L1, the electrical energy can pass from the energy storage cells 12 to the control device 11 and from the control device 11 to the drive 7.

The control device 11 is positioned in the interior of the housing 4 of the power tool 3 and contains, inter alia, a current measuring device 14, voltage measuring device 15 and a communication device 16.

The control device 11 is used to control the individual functions of the power tool 3. The various functions include, inter alia, the adjusting of a particular voltage value or current intensity value for an electrical energy for charging the energy storage cells 12 connected to the charging apparatus 2.

The current measuring device 14 is used to measure or record a current intensity value.

The voltage measuring device 15 is in turn used to measure or record an electric voltage value.

The communication device 16 is used to send and receive electrical signals and can also be referred to as a transceiver or a transceiver unit. The power tool 3 can enter into communication with the charging apparatus 2 by means of the communication device 16. For this purpose, electrical signals for the exchange of data and information are sent and received between the power tool 3 and the charging apparatus 2.

A power tool interface device 17 is positioned in the form of a USB socket at the rear end 4b of the housing 4 of the power tool 3. The power tool interface device 17 embodied as a USB socket is used to receive a USB plug connector and is connected on the inner side of the housing 4 to the energy storage cells 12.

The abbreviation USB stands for “Universal Serial Bus”.

By way of the power tool interface device 17 embodied as a USB socket, electrical energy can pass from the charging apparatus 2 to the energy storage cells 12 for a charging process of the energy storage cells 12. In addition, the power tool interface device 17 embodied as a USB socket can also be used for a discharge process of the energy storage cells 12 when electrical energy is to pass from the energy storage cells 12 to the charging apparatus 2.

In addition, the power tool interface device 17 embodied as a USB socket is also designed such that electrical signals for the exchange of data and information can be sent from and received by the USB socket 17. The USB socket 17 is to this end connected to the communication device 16 via a second line L2.

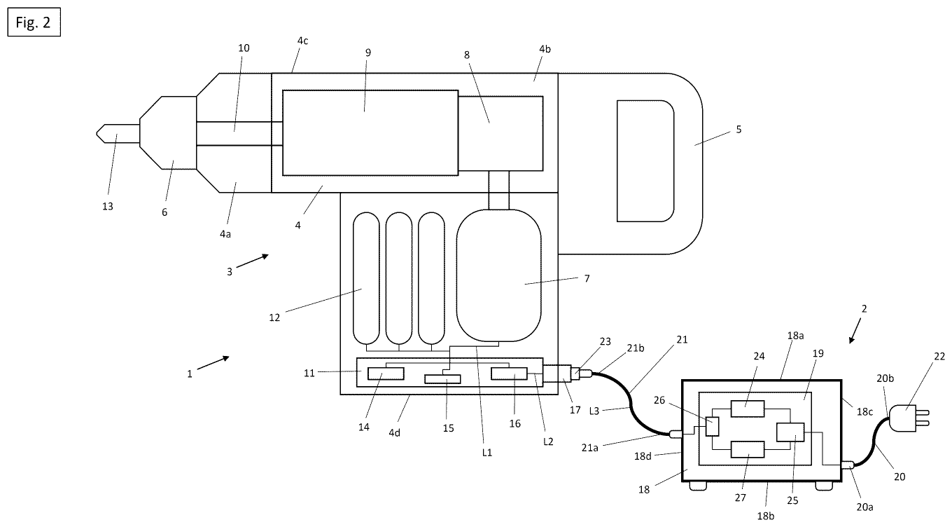

FIG. 2 illustrates the power tool 3 according to the invention according to a second exemplary embodiment. The power tool 3 according to the second exemplary embodiment corresponds substantially to the power tool 3 according to the first exemplary embodiment. In contrast to the first exemplary embodiment, in the second exemplary embodiment the energy storage cells 12 embodied as pouch cells are not positioned in a cavity HR of the housing 4 below the handle 5, but are positioned in a cavity HR next to the drive 7. The control device 11 is additionally disposed below the energy storage cells 12 and the drive 7.

In accordance with a further exemplary embodiment (not shown in the drawings), the energy storage cells 12 configured as pouch cells can also be disposed in a different position inside the housing 4 of the power tool 3, for example around the impact device 9.

The charging apparatus 2 is used here to charge or supply the energy storage cells 12 inside the power tool 3, which are able to be connected to the charging apparatus 2, with electrical energy.

In FIGS. 1 and 2, only one single power tool 3 inclusive of internal energy storage cells 12 is connected to the charging apparatus 2 by way of example. In accordance with an alternative exemplary embodiment not shown in the figures, it can likewise be possible for the charging apparatus 2 to be configured to charge or supply more than one single power tool 3 or energy storage cells 12 thereof with electrical energy. In other words: the charging apparatus 2 can alternatively be capable of charging a plurality of power tools 3 or energy storage cells 12 thereof at the same time.

The charging apparatus 2 shown in FIGS. 1 and 2 fundamentally contains a charger housing 18, a control device 19, a connector cable 20 and a charger interface device 21.

The charger housing 18 here has a top side 18a, bottom side 18b, a first side wall 18c, second side wall 18d, third side wall and fourth side wall. The third side wall and fourth side wall are not shown in the figures. The connector cable 20 is attached to the first side wall 18c and the charger interface device 21 is attached to the second side wall 18d.

The connector cable 20 contains a first end 20a and a second end 20b. The first end 20a attaches the connector cable 20 to the first side wall 18c of the charger housing 18. A plug 22 for a power outlet is positioned at the second end 20b of the connector cable 20, by means of which plug the connector cable 20 can be connected to a power outlet. The power outlet is not shown in the figures.

The charger interface device 21 is configured in the form of a third line L3 having a first end 21a and a second end 21b. The first end 21a is positioned on the second side wall 18c of the charger housing 18. A USB plug connector 23 is positioned at the second end 21b of the charger interface device 21. The USB plug connector 23 is additionally configured to be releasably connected to a correspondingly designed USB socket 17.

As described below in more detail, the connection of the USB plug connector 23 to the USB socket 17 is used not only for transmitting electrical energy but also for transmitting or exchanging data and information in the form of electrical signals.

The control device 19 is positioned in the interior of the charger housing 18 and contains, inter alia, a current measuring device 24, voltage measuring device 25 and a communication device 26.

The control device 19 is used to control and regulate the individual functions of the charging apparatus 2. Among the various functions of the control device 19 are, inter alia, the adjusting of a particular voltage value or current intensity value for an electrical energy for charging an accumulator 3 which is connected to the charging apparatus 2.

The current measuring device 24 is used to measure or record a current intensity value.

The voltage measuring device 25 is in turn used to measure or record a voltage value.

The communication device 26 is used to send and receive electrical signals and can also be referred to as a transceiver or a transceiver unit. The charging apparatus 2 can enter into communication with the power tool 3 by means of the communication device 26. For this purpose, electrical signals for the exchange of data and information are sent and received between the power tool 3 and the charging apparatus 2.

According to the first embodiment of the charging apparatus 2, the communication device 26 contains a communication element 26a and a transmission element 26b. The transmission element 26b is configured by the line L4. Thus, by means of the first line L4, not only the electrical energy but also electrical signals for the exchange of data and information can be exchanged between the charging apparatus 2 and the power tool 3.

By performing a controlled charging process by the charging apparatus 2 for the energy storage cells 12 positioned in the power tool 3, the power tool 3 is firstly releasably connected to the charging apparatus 2, as indicated in FIG. 1. In order to connect the power tool 3 to the charging apparatus 2, the free end of the third line L3 with the USB plug connector 23 of the charging apparatus 2 is connected to the USB socket 17 of the power tool 3. As already mentioned above, by way of the connection of the USB plug connector 23 of the charging apparatus 2 to the USB socket 17 of the accumulator 3, electrical signals can be exchanged between the charging apparatus 2 and the power tool 3.

After connecting the charging apparatus 2 to the power tool 3, a signal is firstly sent from the communication device 16 of the power tool 3 to the communication device 26 of the charging apparatus 2 in order to convey energy storage cell characteristic values. Conveying the energy storage cell characteristic values serves to identify the energy storage cells 12 to the charging apparatus 2. Through the identification, particular properties of the energy storage cells 12 are sent to the charging apparatus 2 in the form of the electrical signals. The properties of the energy storage cells 12 include, for example, a maximum permissible voltage value, current intensity value or power value for charging the energy storage cells 12 with electrical energy.

Alternatively, a signal is transmitted from the communication device 16 of the power tool 3 to the communication device 26 of the charging apparatus 2 in order to thus request or set at the charging apparatus 2 a certain voltage value, current intensity value or power value for a charging of the energy storage cells 12 with electrical energy. The certain voltage value can be 48V, the certain current intensity value can be 5A, or the certain power value can be 240W.

After receiving the corresponding signal regarding the energy storage cell characteristic values, a signal is transmitted from the communication device 26 of the charging apparatus 2 to the communication device 16 of the power tool 3 in order to indicate the charging capacity or compatibility of the charging apparatus 2 and the connected energy storage cells 12 for a charging process.

Subsequently and after receiving this signal, a further signal is sent from the communication device 16 of the power tool 3 to the communication device 26 of the charging apparatus 2 in order to adjust the charging apparatus 2 into a charging state. The charging apparatus 2 is generally configured in such a way that it can be adjusted into a charging state, neutral state (also referred to as “stand-by”) or discharging charge. In the charging state, electrical energy can be sent from the charging apparatus 2 to connected energy storage cells 12 which are suitable for a charging process. In the discharging state, electrical energy can be drawn from the energy storage cells 12 in order to be stored in a corresponding energy storage device 27 of the charging apparatus 2. The energy storage device 27 of the charging apparatus 2 can be embodied in the form of an accumulator cell.

In the neutral state, electrical energy is neither drawn from the connected energy storage cells 12 into the charging apparatus 2 nor delivered from the charging apparatus 2 to connected energy storage cells 12.

Subsequently, the power tool 3 is adjusted from a discharging state into a charging state by way of its control device 11 such that electrical energy provided by the charging apparatus 2 can be drawn or stored by the energy storage cells 12.

After adjusting the power tool 3 into the charging state, a further signal is sent from the communication device 16 of the power tool 3 to the communication device 26 of the charging apparatus 2 in order to adjust at least one first charging characteristic value at the charging apparatus 2. The charging characteristic value can be a voltage value, current intensity value or a charging power value for the charging process.

The voltage value for the charging process can be 21 to 60 volts (V) here. According to the present embodiment, the voltage value is 48 V.

The current intensity value for the charging process can be 1 to 10 amperes (A). According to the present embodiment, the current intensity value is 5 A.

The charging power for the charging process can be 24 to 600 watts (W). According to the present embodiment, the charging power is 210 W.

In a next method step, electrical energy is sent from the charging apparatus 2 to the energy storage cells 12 in accordance with at least one charging characteristic value demanded by the power tool 3. In the present exemplary embodiment, the charging characteristic values for the connected energy storage cells 12 correspond to a charging voltage of 48 V, a charging current intensity of 5 A and a resulting charging power of 240 W.

After a predetermined duration and/or after reaching a predetermined state for the power tool 3, a further signal is sent from the communication device 16 of the power tool 3 to the communication device 26 of the charging apparatus 2 in order to adjust at least one new charging characteristic value at the charging apparatus 2. The new charging characteristic value can be a new charging voltage value, charging current intensity value or charging power.

Both the communication device 16 of the power tool 3 and the communication device 26 of the charging apparatus 2 can be configured wirelessly and in particular by Bluetooth technology.

### LIST OF REFERENCE SIGNS

1 System
2 Charging apparatus
3 Power tool
4 Housing of the power tool
4a Front end of the housing
4b Rear end of the housing
4c Upper end of the housing
4d Lower end of the housing
Handle
6 Tool fitting
7 Drive
8 Gear device
9 Impact device
10 Output shaft
11 Control apparatus
12 Energy storage cell
13 Tool
14 Current measuring device
15 Voltage measuring device
16 Communication device of the power tool
17 Power tool interface device
18 Charger housing
18a Top side of the charger housing
18b Bottom side of the charger housing
18c First side wall of the charger housing
18d Second side wall of the charger housing
19 Control device
20 Connector cable
21 Charger interface device
21a First end of the charger interface device
21b Second end of the charger interface device
22 Plug
23 USB plug connector
24 Current measuring device
25 Voltage measuring device
26 Communication device of the charging apparatus
27 Energy storage device
L1 First line
L2 Second line
L3 Third line

What is claimed is:

1-6. (canceled)

7. A power tool comprising:
a housing;
a drive positioned in the housing;
at least one energy storage cell in the form of a pouch cell positioned inside the housing; and
at least one interface for selectively supplying the at least one energy storage cell with electrical energy.

8. The power tool as recited in claim 7 wherein the at least one interface is designed in the form of a USB socket.

9. The power tool as recited in claim 7 wherein the interface device is configured to allow a supply of the at least one energy storage cell with a voltage value of 21 to 60 V.

10. The power tool as recited in claim 7 wherein the interface device is configured to allow a supply of the at least one energy storage cell with a voltage value of 48 V.

11. The power tool as recited in claim 7 wherein the interface device is configured to allow a supply of the at least one energy storage cell with a current intensity value of 1 to 10 A.

12. The power tool as recited in claim 7 wherein the interface device is configured to allow a supply of the at least one energy storage cell with a current intensity value of 5 A.

13. The power tool as recited in claim 7 wherein the interface device is configured to allow a supply of the at least one energy storage cell with a charging power of 21 to 600 W., in particular 240 W.

14. The power tool as recited in claim 7 wherein the interface device is configured to allow a supply of the at least one energy storage cell with a charging power of 240 W.

15. A system comprising a charging apparatus and at least one power tool as recited in claim 7 connectable to the charging apparatus, the power tool including a first communication device, and the charging apparatus including a second communication device and a charger interface, so that the charging apparatus and the power tool are connectable to charge the at least one energy storage cell with electrical energy, wherein the charger interface is configured in the form of a USB plug connector and the interface is configured in the form of a USB socket.
